(19) United States
(12) Patent Application Publication
(10) Pub. No.: US 2005/0262327 A1
(43) Pub. Date: Nov. 24, 2005

(54) Data transfer control circuit, control apparatus and data transfer method

(75) Inventor: Mitsuhide Yoshimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/131,230

(22) Filed: May 18, 2005

(30) Foreign Application Priority Data
May 19, 2004 (JP) 149183/2004

(51) Int. Cl. G06F 13/28; G06F 12/00

(52) U.S. Cl. 711/202; 710/305

(57) ABSTRACT

A data transfer control circuit is connected between a first bus and a second bus. The first bus is connected with a first CPU and a first memory. The second bus is connected with a second CPU and a second memory. The data transfer control circuit includes a temporary memory and a control unit. The temporary memory is configured to temporarily stores a first address and a first write data which are outputted by the first CPU through the first bus. The control unit is configured to translate the first address into a second address in the second memory with reference to an address translation table. The control unit occupies the second bus to write the first write data to the second address in the second memory through the second bus, when the first CPU releases the first bus after outputting the first address and the first write data to the data transfer control circuit through the first bus.

### BACKGROUND OF THE INVENTION

1. Field of the Invention

The present invention relates to a data transfer control circuit, a control apparatus and a data transfer method. More particularly, the present invention relates to a data transfer control circuit, a control apparatus and a data transfer method with regard to a data transfer between CPUs (Central Processing Units).

2. Description of the Related Art

In recent years, in order to improve a data processing performance, attention has been paid to a technique in which a data processing is shared and executed by a plurality of CPUs and a technique in which a data processing is executed in parallel by a plurality of CPUs. In these techniques, a data transfer is required between the plurality of CPUs. The data transfer method by using a serial transfer and the data exchange method through a shared memory are known as such data transfer methods.

In conjunction with the above description, Japanese Laid Open Patent Application (JP 2002-108835 A) discloses an on-vehicle electronic control apparatus. In this document, the inter-CPU data transfer method by using the serial transfer is disclosed.

This on-vehicle electronic control apparatus is an apparatus whose power source is supplied through a power source switch from an on-vehicle battery. It includes a main CPU, a sub CPU, and a serial-parallel converter for a full-duplex two-way serial communication. Here, the main CPU has a first non-volatile memory, a first RAM memory and a first input/output port. A first control program corresponding to a controlled car and control constants are at least written to the first non-volatile memory from an external tool. The first RAM memory is used for a calculation processing. The sub CPU has a second non-volatile memory, a second RAM memory and a second input/output port. A second control program is written to the second non-volatile memory. The second RAM memory is used for the calculation processing. The serial-parallel converter for the full-duplex two-way serial communication mutually carries out a data communication between the main CPU and the sub CPU during the operation of the controlled car. Then, at a time of an operation start of the controlled car, a part of the control constants stored in the first non-volatile memory is transferred through the serial-parallel converter for the serial communication to the second RAM memory. The sub CPU carries out a predetermined processing on the basis of the content of the second control program of the second non-volatile memory and the content of the control constant transferred to the second RAM memory.

However, it has now been discovered that a transfer rate of data is determined by a communication rate of a serial I/F in the above case of the serial transfer. That is, the transfer rate is limited by the performance of the serial I/F. For this reason, even if the communication rate is made higher in order to transfer a large amount of data at a higher speed, it is much slower than an operation speed of the CPU. Thus, the higher speed cannot be attained.

Moreover, in the case of the shared memory, it is necessary to carry out an exclusion control through software. That is, this requires the executing of a protocol control through a semaphore and the like and the enlarging of a memory size for the area sharing in the shared memory. Thus, the control of the software becomes complex. If the perfect exclusion control cannot be carried out because of the duplication of semaphore flags caused by access competition, there may be a risk of an occurrence that the data is overwritten. If a plurality of semaphore areas are prepared, this leads to the size increase in the shared memory and results in the cost increase.

For this reason, a technique is desired which can obtain a sufficient transfer rate that can correspond to the operation speed of the CPU without any increase in the cost, in the data transfer between the CPUs.

### SUMMARY OF THE INVENTION

It is therefore an object of the present invention to provide a data transfer circuit, a control apparatus and a data transfer method, which can obtain the sufficient transfer rate that can handle the operation speed of the CPU, in the data transfer between the CPUs.

In order to achieve an aspect of the present invention, the present invention provides a data transfer control circuit which is connected between a first bus and a second bus, wherein the first bus is connected with a first CPU (Central Processing Unit) and a first memory, the second bus is connected with a second CPU and a second memory, the data transfer control circuit including: a temporary memory configured to temporarily stores a first address and a first write data which are outputted by the first CPU through the first bus; and a control unit configured to translate the first address into a second address in the second memory with reference to an address translation table, wherein the control unit occupies the second bus to write the first write data to the second address in the second memory through the second bus, when the first CPU releases the first bus after outputting the first address and the first write data to the data transfer control circuit through the first bus.

According to the present invention, the first CPU can recognizes the memory region in the second memory through the virtual memory space, thereby write and read data, even though the second memory belongs to the second CPU. Since the first CPU can easily access the second memory by using the data transfer control circuit, a device driver used for a communication control is not required. A use code amount can be reduced and a cord memory can be effectively utilized. The shared memory used for only the data transfer becomes unnecessary which can reduce a hardware quantity.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the configuration of the embodiment of the control apparatus of the present invention;

FIG. 2 is a view showing an address translation in the embodiment of the control apparatus of the present invention;

FIG. 3 is a view showing the address translation table stored in the main control unit in the embodiment of the present invention;

FIG. 4 is a time chart showing the operation of an embodiment of a data transfer method of the present invention;

FIG. 5 is a time chart showing the operation of the embodiment of the data transfer method of the present invention; and

FIG. 6 is a time chart showing another operation of the embodiment of the data transfer method of the present invention.

### DESCRIPTION OF THE PREFERRED EMBODIMENTS

Embodiment of a data transfer control circuit, a control apparatus and a data transfer method of the present invention will be described below with reference to the attached drawings.

At first, the configuration of the embodiment of the data transfer control circuit of the present invention and the control apparatus will be described.

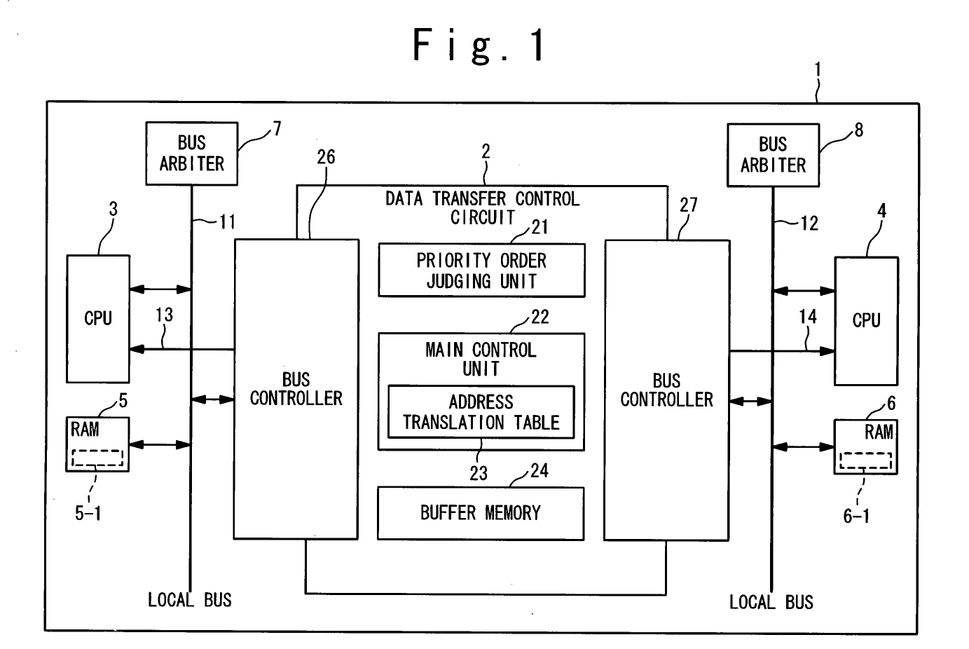

FIG. 1 is a block diagram showing the configuration of the embodiment of the control apparatus of the present invention. The control apparatus 1 includes a data transfer control circuit 2, a CPU (Central Processing Unit) 3, a CPU 4, a RAM (Random Access Memory) 5, a RAM 6, a bus arbiter 7, a bus arbiter 8, a local bus 11, a local bus 12, a signal line 13 and a signal line 14.

The CPU 3 as the first CPU is connected to the local bus 11. The RAM 5 as the first memory is connected to the local bus 11 and belongs to the CPU 3. The RAM 5 has a memory region 5-1 assigned to the CPU 4, in addition to a memory region (not shown) assigned to the CPU 3. The RAM 5 may be a different kind of a memory device. The local bus 11 as the first bus is connected to the bus arbiter 7, the CPU 3, the RAM 5 and the data transfer control circuit 2. The bus arbiter 7 controls the transfer of data through the local bus 11.

The CPU 4 as the second CPU is connected to the local bus 12. The RAM 6 as the second memory is connected to the local bus 12 and belongs to the CPU 4. The RAM 6 has a memory region 6-1 assigned to the CPU 3, in addition to a memory region assigned to the CPU 4. The RAM 6 may be a different kind of a memory device. The local bus 12 as the second bus is connected to the bus arbiter 8, the CPU 4, the RAM 6 and the data transfer control circuit 2. The bus arbiter 8 controls the transfer of data through the local bus 12.

The data transfer control circuit 2 arbitrates the transfer of the data between the CPU 3 and the RAM 6 belonging to the CPU 4, and the transfer of the data between the CPU 4 and the RAM 5 belonging to the CPU 3. The data transfer control circuit 2 has a priority order judging unit 21, a main control unit 22, a buffer memory 24, a bus controller 26 and a bus controller 27.

The buffer memory 24 as the temporary memory temporarily stores a write data outputted through the local bus 11 by the CPU 3 and a real address of a writing destination for the write data, at the time of the writing operation of the CPU 3. The buffer memory 24 temporarily stores a real address of a read data outputted through the local bus 11 by the CPU 3 and a read request data indicating a read request of the read data, at the time of the reading operation of the CPU 3.

Similarly, the buffer memory 24 temporarily stores a write data outputted through the local bus 12 by the CPU 4 and a real address of a writing destination for the write data, at the time of the writing operation of the CPU 4. The buffer memory 24 temporarily stores a real address a read data outputted through the local bus 12 by the CPU 4 and a read request data indicating a read request of the read data, at the time of the reading operation of the CPU 4.

The priority order judging unit 21 as the judging unit judges whether or not the data transfer control circuit 2 outputs the real address and the write data through the local bus 12, at the time of the writing operation of the CPU 3. The priority order judging unit 21 also judges whether or not the data transfer control circuit 2 outputs the real address and the read request data through the local bus 12, at the time of the reading operation of the CPU 3.

Similarly, the priority order judging unit 21 judges whether or not the data transfer control circuit 2 outputs the real address and the write data through the local bus 11, at the time of the writing operation of the CPU 4. The priority order judging unit 21 also judges whether or not the data transfer control circuit 2 outputs the real address and the read request data through the local bus 11, at the time of the reading operation of the CPU 4.

That is, the priority order judging unit 21 determines (judges) the priority order of each of a plurality of sets of the real address and the write data to output the each of the plurality of sets in the priority order.

An example of a method of determining a priority order is as follows. When the data are stored in the buffer memory 24, they are stored in relation to identifiers based on a predetermined rule. The priority order is determined based on the identifier corresponding to each data. If the identifier is assumed to be the number starting from the smaller numeral in the data storage order and if the data processing is executed in the order of increasing the identifier, the priority order becomes the order of increasing the identifier. However, the determining method is not limited to this method.

The main control unit 22 as the control unit has an address translation table 23. The main control unit 22 refers to the address translation table 23 and translates the real address outputted from the CPU 3 into the real address on the RAM 6.

At the time of the writing operation of the CPU 3, if the priority order judging unit 21 judges that the writing of the write data has the highest priority order, the main control unit 22 writes this write data through the local bus 12 to the real address of the RAM 6. After the CPU 3 releases the local bus 11, the main control unit 22 may occupy the local bus 12 and write this write data through the local bus 12 to the real address of the RAM 6.

At the time of the reading operation of the CPU 3, if the priority order judging unit 21 judges the reading of the read data has the highest priority order, the main control unit 22 reads this read data through the local bus 12 from the real address of the RAM 6. After the CPU 3 releases the local bus 11, the main control unit 22 may occupy the local bus 12 and read this read data through the local bus 12 from the real address of the RAM 6.

Similarly, the main control unit 22 refers to the address translation table 23 and translates the real address outputted from the CPU 4 into the real address on the RAM 5.

At the time of the writing operation of the CPU 4, if the priority order judging unit 21 judges the writing of the write data has the highest priority order, the main control unit 22 writes this write data through the local bus 12 to the real address of the RAM 6. After the CPU 4 releases the local bus 12, the main control unit 22 may occupy the local bus 11 and write this write data through the local bus 11 to the real address of the RAM 5.

At the time of the reading operation of the CPU 4, if the priority order judging unit 21 judges the reading of the read data has the highest priority order, the main control unit 22 reads this read data through the local bus 11 from the real address of the RAM 5. After the CPU 4 releases the local bus 12, the main control unit 22 may occupy the local bus 11 and read the read data through the local bus 11 from the real address of the RAM 5.

A bus controller 26 is connected to the local bus 11 and controls the input/output of data between the data transfer control circuit 2 and the local bus 11. The bus width of bus controller 26 corresponds to a first bus width of the local bus 11.

A bus controller 27 is connected to the local bus 12 and controls the input/output of data between the data transfer control circuit 2 and the local bus 12. The bus width of bus controller 27 corresponds to a second bus width of the local bus 12.

The first bus width may be different from the second bus width. In this case, it is enough to handle them by any of the following two methods.

(1) The bus controller 27 converts the bus width (the first bus width) of the write data, which is outputted from the CPU 3, into the second bus width. Then, the bus controller 27 outputs the converted write data to the local bus 12. The bus controller 26 converts the bus width (the second bus width) of the write data, which is outputted from the CPU 4, into the first bus width. Then, the bus controller 29 outputs the converted write data to the local bus 11.

(2) The main control unit 22 converts the bus width (the first bus width) of the write data, which is outputted from the CPU 3, into the second bus width. Then, the main control unit 22 outputs the converted write data through the bus controller 27 to the local bus 12. The main control unit 22 converts the bus width (the second bus width) of the write data, which is outputted from the CPU 4, into the first bus width. Then, the main control unit 22 outputs the converted write data through the bus controller 26 to the local bus 11.

The control apparatus 1 may be the semiconductor device such as LSI (Large Scale Integrated Circuit) that includes all of the respective configurations (the data transfer control circuit 2, the CPU 3, the CPU 4, the RAM 5, the RAM 6, the bus arbiter 7, the bus arbiter 8, the local bus 11 and the local bus 12) in one chip. Or, the control apparatus 1 may be the device having the shape of a board where a part of the respective configurations or all of them are individual chips.

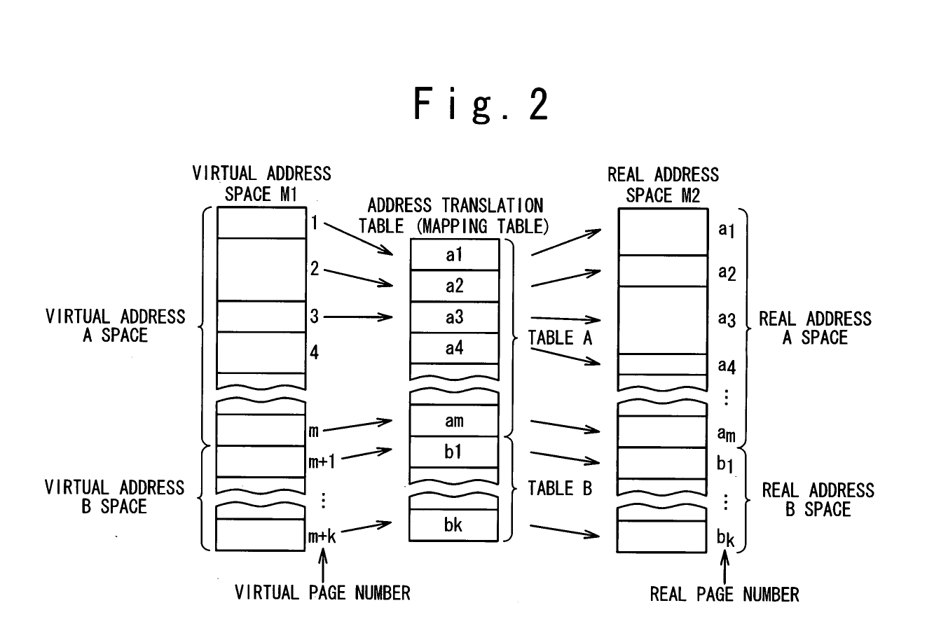

FIG. 2 is a view showing an address translation in the embodiment of the control apparatus of the present invention. Here, address translation in the CPU 3 is explained. Address translation in the CPU 4 is similar to that in the CPU3. A virtual address space M1 shows a virtual address space recognized by the CPU 3. A real address space M2 shows a real address space in the actual memory (the RAM 5 and the RAM 6 in this embodiment). In the CPUs 3, an address translation table (mapping table) relates the virtual address space M1 and the real address space M2. Here, an example is explained, in which the mapping is carried out through paging. However, the present invention is not limited thereto. It can be similarly executed even if the mapping is carried out by another method such as a segmentation or a page segmentation.

The virtual address space M1 includes a virtual address A space of virtual page numbers 1 to m (m: a natural number) and a virtual address B space of virtual page numbers m+1 to m+k (k: a natural number). The real address space M2 includes a real address A space of real page numbers a₁ to aₘ and a real address B space of real page numbers b₁ to bₖ. The address translation table in the CPU3 relates the virtual address A space to the real address A space in a table A and relates the virtual address B space to the real address B space in a table B, respectively.

Here, in the CPU 3, the real address A space shows the address of the RAM 5 belonging to the CPU 3. The real address B space shows the address of a memory region 6-1 assigned to the CPU 3 in the RAM 6 belonging to the CPU 4.

Similarly, in the CPU 4, the real address A space shows the address of the RAM 6 belonging to the CPU 4. The real address B space shows the address of a memory region 5-1 assigned to the CPU 4 in the RAM 5 belonging to the CPU 3.

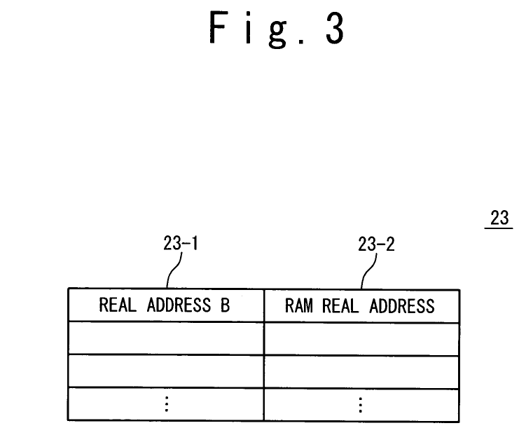

FIG. 3 is a view showing the address translation table stored in the main control unit in the embodiment of the present invention. The address translation table 23 relates a real address B 23-1 and a RAM real address 23-2. The real address B 23-1 is the address in the real address B space indicated in the address translation table the CPUs 3 and 4. The RAM real address 23-2 is the real address in the RAMs 6 and 5. The real address B 23-1 includes both of the real address B specified by the CPU 3 and the real address B specified by the CPU 4. Correspondingly thereto, the RAM real address 23-2 includes both of the real address of the memory region 6-1 of the RAM 6 corresponding to the real address B specified by the CPU 3 and the real address of the memory region 5-1 of the RAM 5 corresponding to the real address B specified by the CPU 4.

As shown in FIG. 2 and FIG. 3, the RAM 6 of the CPU 4 is in the situation that it is virtually incorporated into a part of the memory map of the CPU 3. For this reason, the CPU 3 can easily access a memory region 6-1 of a different CPU 4 by specifying the address of the virtual address B space in the virtual address space M1, in the usual memory access. Similarly, the RAM 5 of the CPU 3 is in the situation that it is virtually incorporated into a part of the memory map of the CPU 4. For this reason, the CPU 4 can easily access a memory region 5-1 of a different CPU 3 by specifying the address of the virtual address B space in the virtual address space M1, in the usual memory access. Thus, the device driver to be used for the communication control for accessing the memory region of the CPU 4 is not required.

In addition, if a different memory is connected to the local bus 12, the address translation table in the CPU 3 may relate a part of the virtual address B space (a part of the real address B space) to a predetermined memory region in the different memory. In this case, the predetermined memory region in the different memory is assigned to the CPU 3. Thus, similarly to the above-mentioned case, the CPU 3 can easily access the predetermined memory region in the different memory.

Similarly, if a different memory is connected to the local bus 11, the address translation table in the CPU 4 may relate a part of the virtual address B space (a part of the real address B space) to a predetermined memory region in the different memory. In this case, the predetermined memory region in the different memory is assigned to the CPU 4. Thus, similarly to the above-mentioned case, the CPU 4 can easily access the predetermined memory region in the different memory.

Also, as for a different local bus that is connected to a different CPU and a different RAM and differs from the local buses 11, 12, a different bus controller is newly installed in the data transfer control circuit 2 (multi-cast), and the data transfer control circuit 2 and the different local bus can be connected. Then, the region assigned to each CPU is installed in each RAM, and the relation setting as shown in FIGS. 2, 3 is performed so that each CPU can easily access each RAM corresponding to the different CPU.

The operation of the embodiment of the control apparatus of the present invention (the embodiment of the data transfer method) will be described below.

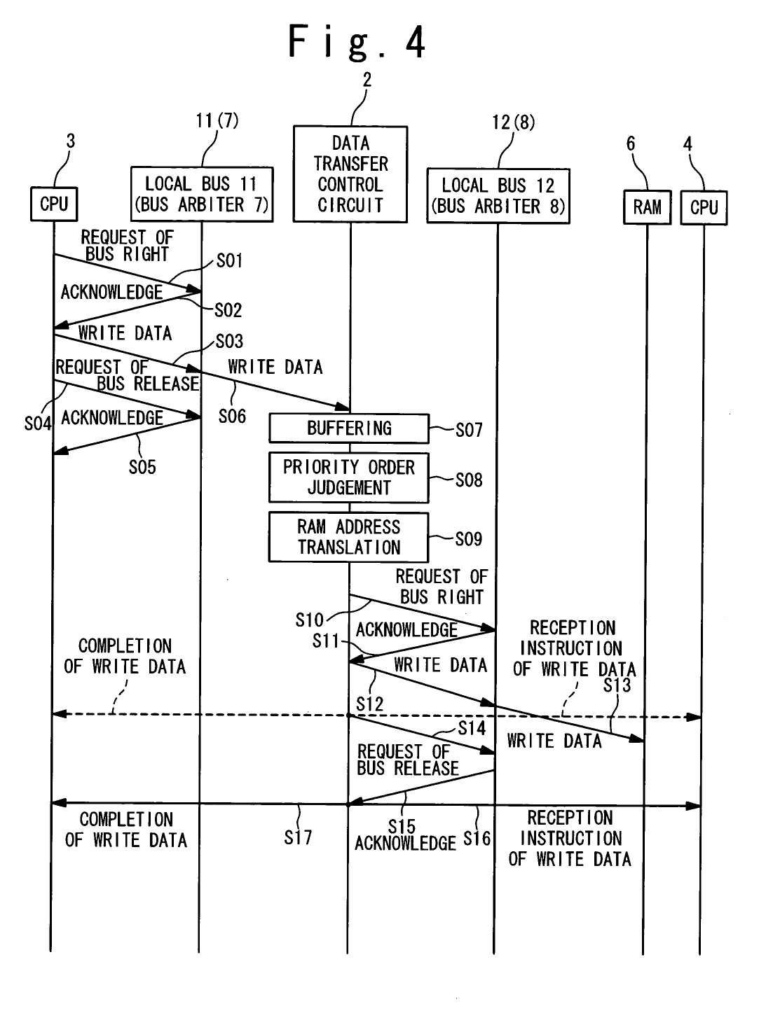

At first, the operation when the CPU 3 writes the write data to the RAM 6 belonging to the CPU 4 will be described. FIG. 4 is a time chart showing the operation of an embodiment of a data transfer method of the present invention (the operation when the CPU 3 writes the write data to the RAM 6).

(1) Step S01: The CPU 3 outputs a signal for request of a bus right to the bus arbiter 7.

(2) Step S02: The bus arbiter 7 outputs a signal for acknowledging the request of the bus right to the CPU 3, based on a predetermined condition.

(3) Step S03: The CPU 3 outputs (transmits) the write data and the address of the real address B space (hereafter, referred to as the real address B) in the real address space M2 explained in FIG. 2, to the local bus 11 for the data transfer control circuit 2 in order to write the write data to the RAM 6.

(4) Step S04: After outputting the real address B and the write data at the step S03, the CPU 3 outputs a signal (request) for request of releasing the bus to the bus arbiter 7.

(5) Step S05: The bus arbiter 7 outputs the signal (acknowledge) for releasing the bus to the CPU 3, based on a predetermined condition.

(6) Step S06: The data transfer control circuit 2 receives the real address B and the write data through the local bus 11.

(7) Step S07: The main control unit 22 of the data transfer control circuit 2 assigns an identifier to the real address B and the write data and temporarily stores (buffers) them in the buffer memory 24. The identifier indicates, for example, the order of storing these data in the buffer memory 24.

(8) Step S08: The priority order judging unit 21 of the data transfer control circuit 2 judges whether or not there is another data processing with a higher priority order in the data transfer control circuit 2. That is, the priority order judging unit 21 judges whether or not the data processing for outputting (writing) the write data through the local bus 12 to the RAM 6 can be acknowledged.

For example, the priority order judging unit 21 judges whether or not there are another real address B and write data to be written to the RAM 6 (or the RAM 5) (or the address of the data to be read from the RAM 6 (or the RAM 5)) in the buffer memory 24. Here, the other real address B and write data are data that are already stored, and that should be processed ahead. If not, the writing of this write data is executed.

(9) Step S09: The main control unit 22 of the data transfer control circuit 2 refers to the address translation table 23 and translates the real address B (real address B 23-1) into the real address (RAM real address 23-2) on the RAM 6.

(10) Step S10: The main control unit 22 outputs the signal for request of the bus right to the bus arbiter 8, based on the judgment that the data processing for outputting (writing) the write data to the RAM 6 can be acknowledged at the step S06.

(11) Step S1: The bus arbiter 8 outputs the signal for acknowledging the request of the bus right to the data transfer control circuit 2, based on a predetermined condition.

(12) Step S12: The main control unit 22 outputs (transmits) the real address on the RAM 6 and write data to the local bus 12 for the RAM 6. At that time, if the first bus width of the local bus 11 and the second bus width of the local bus 12 are different, the bus controller 27 converts the bus width (the first bus width) of the real address and write data into the second bus width. This conversion may be done by the main control unit 22.

(13) Step S13: The RAM 6 writes the write data to the received real address.

(14) Step S14: After outputting the real address and the write data at the step S10, the main control unit 22 of the data transfer control circuit 2 outputs the signal for request of releasing the bus 12 to the bus arbiter 8.

(15) Step S15: The bus arbiter 8 outputs the signal for releasing the bus 12 to the data transfer control circuit 2, based on a predetermined condition.

(16) Step S16: The main control unit 22 outputs a signal for indicating a reception instruction of the write data to the CPU 4 through a signal line 14 for a control signal, after the step S12.

(17) Step S17: The main control unit 22 outputs a signal for indicating a reception completion of the write data to the CPU 3 through a signal line 13 for the control signal, after the step S12.

With the above operation, the CPU 3 can write the write data to the RAM 6. The operation that the CPU 4 writes the write data to the RAM 5 belonging to the CPU 3 is similar to the above operation.

In the above operation, in the data writing to the RAM 6 by the CPU 3, the respective local bus 11 and local bus 12 are never occupied at the same time. That is, the local bus is designed to be occupied when it is necessary to be occupied. Consequently, the occupation periods of the local buses 11, 12 can be made shorter. Then, the local buses 11, 12 can be used effectively.

In the above operation, the step S04 is desired to be executed immediately after the end of the step S03. Consequently, the occupation period of the local bus 11 in the data writing to the RAM 6 by the CPU 3 can be made shorter.

Similarly, in the above operation, the step S14 is desired to be executed immediately after the end of the step S12. Consequently, the occupation period of the local bus 12 in the data writing to the RAM 6 by the CPU 3 can be made shorter.

The steps S16, S17 may be executed immediately after the end of the step S12. Also, the writing of the write data to the RAM 5 by the CPU 4 can be similarly executed.

According to the present invention, the CPU 3 can easily access the RAM 6 of the different CPU 4 by carrying out the operation of the usual memory access. Thus, the device driver used for the communication control is not required. The use code amount can be reduced that enables the effective utilization of the code memory. The shared memory used only for the data transfer is not required that enables the drop in the hardware quantity.

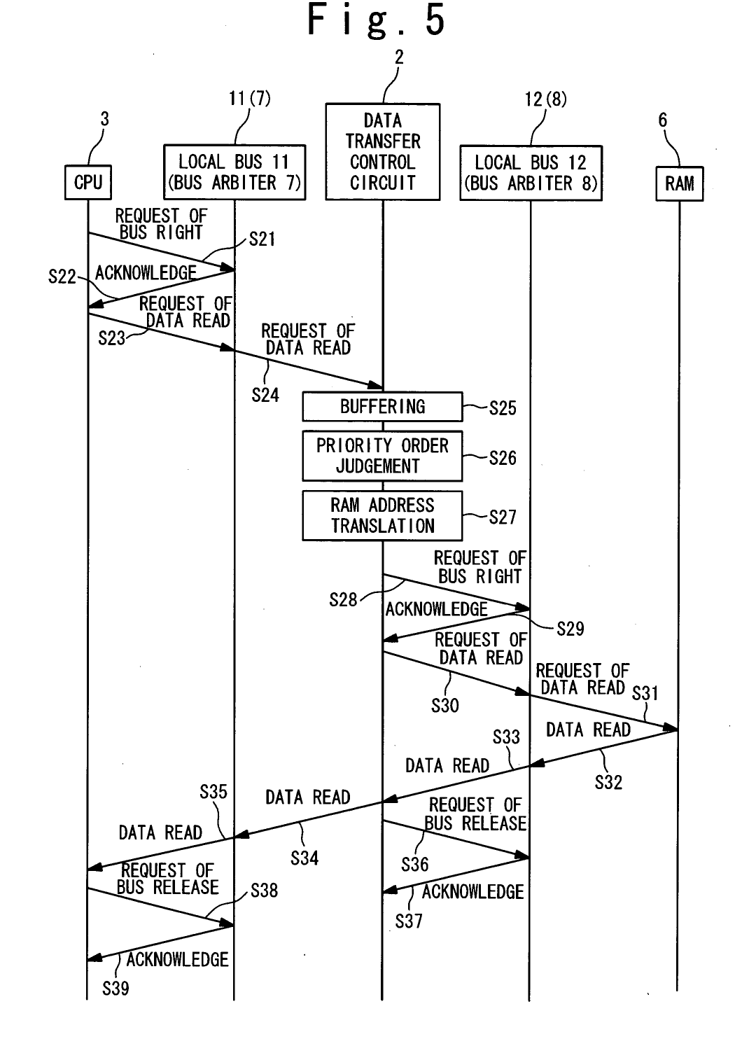

The operation when the CPU 3 reads the data of the RAM 6 belonging to the CPU 4 will be described below. FIG. 5 is a time chart showing the operation of the embodiment of the data transfer method of the present invention (the operation that the CPU 3 reads the data of the RAM 6).

(1) Step S21: The CPU 3 outputs the signal for request of the bus right to the bus arbiter 7.

(2) Step S22: The bus arbiter 7 outputs the signal for acknowledging the request of the bus right to the CPU 3, based on a predetermined condition.

(3) Step S23: The CPU 3 outputs (transmits) the address of the real address B space (hereafter, referred to as the real address B) in the real address space M2 explained in FIG. 2 and the read request data indicative of a data reading request, to the local bus 11 for the data transfer control circuit 2 in order to read the data from the RAM 6.

(4) Step S24: The data transfer control circuit 2 receives the real address B and the read request data through the local bus 11.

(5) Step S25: The main control unit 22 of the data transfer control circuit 2 assigns the identifier to the real address B and the read request data and temporarily stores (buffers) them in the buffer memory 24. The identifier indicates, for example, the order of storing in the buffer memory 24.

(6) Step S26: The priority order judging unit 21 of the data transfer control circuit 2 judges whether or not there is another data processing with the higher priority order in the data transfer control circuit 2. That is, the priority order judging unit 21 judges whether or not the data processing for reading the data through the local bus 12 from the RAM 6 can be acknowledged.

For example, the priority order judging unit 21 judges whether or not there are the data already read from the RAM 6 (or the RAM 5) (or the real address B and write data to be written to the RAM 6 (or the RAM 5)) in the buffer memory 24. Here, the data already read are data that are already stored, and that should be processed ahead. If not, the reading of this data is executed.

(7) Step S27: The main control unit 22 of the data transfer control circuit 2 refers to the address translation table 23 and translates the real address B (real address B 23-1) into the real address (RAM real address 23-2) on the RAM 6.

(8) Step S28: The main control unit 22 outputs the signal for request of the bus right to the bus arbiter 8, based on the judgment that the data processing for reading the data from the RAM 6 can be acknowledged at the step S26.

(9) Step S29: The bus arbiter 8 outputs the signal for acknowledging the request of the bus right to the data transfer control circuit 2, based on a predetermined condition.

(10) Step S30: The main control unit 22 outputs (transmits) the real address and read request data on the RAM 6 to the local bus 12 for the RAM 6. At that time, if the first bus width of the local bus 11 and the second bus width of the local bus 12 are different, the bus controller 27 converts the bus width (the first bus width) of real address and read request data into the second bus width. This conversion may be done by the main control unit 22.

(11) Step S31: The RAM 6 receives the real address and read request data on the RAM 6 through the local bus 12.

(12) Step S32: The RAM 6 reads the read data as the data stored in the real address, based on the received real address. Then, the RAM 6 outputs the read data to the local bus 12 for the data transfer control circuit 2 in order to send the read data to the CPU 3.

(13) Step S33: The main control unit 22 of the data transfer control circuit 2 receives the read data.

(14) Step S34: The main control unit 22 outputs the read data to the local bus 11 in order to send the read data to the CPU 3.

(15) Step S35: The CPU 3 receives the read data through the local bus 11.

(16) Step S36: After receiving the reading data at the step S33, the data transfer control circuit 2 outputs the signal for request of releasing the bus 12 to the bus arbiter 8.

(17) Step S37: The bus arbiter 8 outputs the signal for releasing the bus 12 to the data transfer control circuit 2, based on a predetermined condition.

(18) Step S38: After receiving the reading data, the CPU 3 outputs the signal for request of releasing the bus 11 to the bus arbiter 7.

(19) Step S39: The bus arbiter 7 outputs the signal for releasing the bus 11 to the CPU 3, based on a predetermined condition.

With the above operation, the CPU 3 can read the data stored in the RAM 6. The operation that the CPU 4 reads the data stored in the RAM 5 is similar to the above operation.

In the above operation, the step S36 is desired to be executed immediately after the end of the step S33. Consequently, the occupation period of the local bus 12 when the data transfer control circuit 2 reads the data of the RAM 6 can be made shorter.

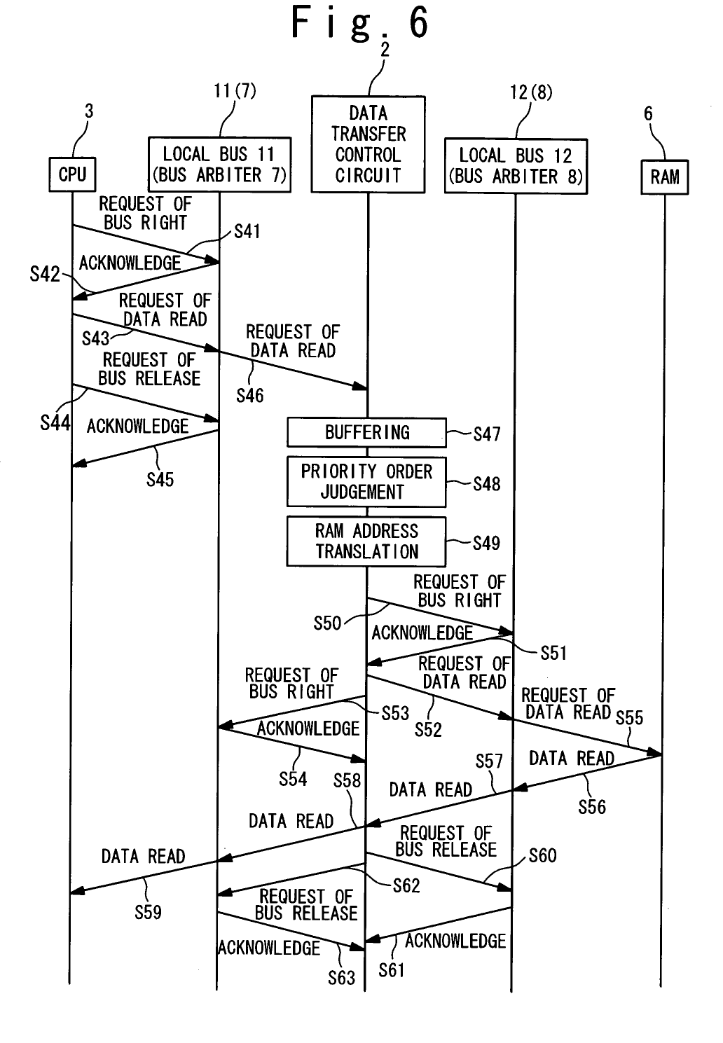

When the CPU 3 reads the data of the RAM 6 belonging to the CPU 4 in out of order, a different operation can be used. FIG. 6 is a time chart showing another operation of the embodiment of the data transfer method of the present invention when the data is read in out of order.

(1) Step S41: The CPU 3 outputs the signal for request of the bus right to the bus arbiter 7.

(2) Step S42: The bus arbiter 7 outputs the signal for acknowledging the request of the bus right to the CPU 3, based on the predetermined condition.

(3) Step S43: The CPU 3 outputs (transmits) the address of the real address B space (hereafter, referred to as the real address B) in the real address space M2 explained in FIG. 2 and the read request data indicative of the data reading request, to the local bus 11 for the data transfer control circuit 2 in order to read the data from the RAM 6.

(4) Step S44: After outputting the real address B and the read request data at the step S43, the CPU 3 outputs the signal for request of releasing the bus 11 to the bus arbiter 7.

(5) Step S45: The bus arbiter 7 outputs the signal for releasing the bus 11 to the CPU 3, based on the predetermined condition.

(6) Step S46: The data transfer control circuit 2 receives the real address B and the read request data through the local bus 11.

(7) Step S47: The main control unit 22 of the data transfer control circuit 2 assigns the identifier to the real address B and the read request data and temporarily stores (buffers) them in the buffer memory 24. The identifier indicates, for example, the order of storing in the buffer memory 24.

(8) Step S48: The priority order judging unit 21 of the data transfer control circuit 2 judges whether or not there is another data processing with the higher priority order in the data transfer control circuit 2. That is, the priority order judging unit 21 judges whether or not the data processing for reading the data through the local bus 12 from the RAM 6 can be acknowledged.

For example, the priority order judging unit 21 judges whether or not there are the data already read from the RAM 6 (or the RAM 5) (or the real address B and write data to be written to the RAM 6 (or the RAM 5)) in the buffer memory 24. Here, the data already read are data that are already stored, and that should be processed ahead. If not, the reading of this data is executed.

(9) Step S49: The main control unit 22 of the data transfer control circuit 2 refers to the address translation table 23 and translates the real address B (real address B 23-1) into the real address (RAM real address 23-2) on the RAM 6.

(10) Step S50: The main control unit 22 outputs the signal for request of the bus right to the bus arbiter 8, based on the judgment that the data processing for reading the data from the RAM 6 can be acknowledged at the step S48.

(11) Step S51: The bus arbiter 8 outputs the signal for acknowledging the request of the bus right to the data transfer control circuit 2, based on the predetermined condition.

(12) Step S52: The main control unit 22 outputs (transmits) the real address and read request data on the RAM 6 to the local bus 12 for the RAM 6. At that time, if the first bus width of the local bus 11 and the second bus width of the local bus 12 are different, the bus controller 27 converts the bus width (the first bus width) of the real address and read request data into the second bus width. This conversion may be done by the main control unit 22.

(13) Step S53: After outputting the real address and the read request data at the step S52, the data transfer control circuit 2 outputs the signal for request of the bus right to the bus arbiter 7.

(14) Step S54: The bus arbiter 7 outputs the signal for acknowledging the bus right to the data transfer control circuit 2, based on the predetermined condition.

(15) Step S55: The RAM 6 receives the real address and read request data on the RAM 6 through the local bus 12.

(16) Step S56: The RAM 6 reads the read data as the data stored in the real address, based on the received real address. Then, the RAM 6 outputs the read data to the local bus 12 for the data transfer control circuit 2 in order to send the read data to the CPU 3.

(17) Step S57: The main control unit 22 of the data transfer control circuit 2 receives the read data.

(18) Step S58: The main control unit 22 outputs the read data to the local bus 11 in order to send the read data to the CPU 3.

(19) Step S59: The CPU 3 receives the read data through the local bus 11.

(20) Step S60: After receiving the reading data at the step S57, the data transfer control circuit 2 outputs the signal for request of releasing the bus 12 to the bus arbiter 8.

(21) Step S61: The bus arbiter 8 outputs the signal for releasing the bus 12 to the data transfer control circuit 2, based on the predetermined condition.

(22) Step S62: After outputting the reading data at the step S58, the data transfer control circuit 2 outputs the signal for request of releasing the bus 11 to the bus arbiter 7.

(23) Step S63: The bus arbiter 7 outputs the signal for releasing the bus 11 to the CPU 3, based on the predetermined condition.

From the above operation, the CPU 3 can read the data stored in the RAM 6. The operation when the CPU 4 reads the data stored in the RAM 5 is similar to the above operation.

In the above operation, between the step S45 and the step S52, the local bus 11 is released that enables the reduction in the occupation period of the local bus 11. Then, the local bus 11 can be used further effectively.

As shown in FIGS. 4 to 6, the writing and reading operations can be carried out by collectively gathering the predetermined number of the data, correspondingly to the size of the buffer memory 24.

In the case of the writing operation, a plurality of sets of the real addresses and write data may be outputted to the data transfer control circuit 2. Or, the head address of the real address and the number of the data as the data with regard to the address, together with the plurality of write data, may be outputted to the data transfer control circuit 2.

In the case of the reading operating, a plurality of the real addresses and one read request data may be outputted to the data transfer control circuit 2. Or, the head address of the real address and the number of the data as the data with regard to the address, together with one read request data, may be outputted to the data transfer control circuit 2.

The above design can reduce the overhead of the arbitration for request of the bus right to the bus arbiter. Consequently, the time necessary for the writing operation and reading operation of the data can be made short, which enables the further effective usage of the CPU and local bus.

It is apparent that the present invention is not limited to the above embodiment, that may be modified and changed without departing form the scope and spirit of the invention.

1. A data transfer control circuit which is connected between a first bus and a second bus, wherein said first bus is connected with a first CPU (Central Processing Unit) and a first memory, said second bus is connected with a second CPU and a second memory, said data transfer control circuit comprising:
a temporary memory configured to temporarily stores a first address and a first write data which are outputted by said first CPU through said first bus; and
a control unit configured to translate said first address into a second address in said second memory with reference to an address translation table,
wherein said control unit occupies said second bus to write said first write data to said second address in said second memory through said second bus, when said first CPU releases said first bus after outputting said first address and said first write data to said data transfer control circuit through said first bus.

2. The data transfer control circuit according to claim 1, further comprising:
a judging unit configured to judge whether or not outputting said first write data through said second bus is acknowledged,
wherein said control unit writes said first write data to said second address in said second memory through said second bus.

3. The data transfer control circuit according to claim 1, further comprising:
a first bus controller configured to be connected with said first bus and have a first bus width corresponds to that of said first bus; and
a second bus controller configured to be connected with said second bus and have a second bus width corresponds to that of said second bus,
wherein said first bus width is different from said second bus width,
said second bus controller converts said first bus width of said write data into said second bus width, and outputs said converted write data to said second bus.

4. The data transfer control circuit according to claim 1, further comprising:
a first bus controller configured to be connected with said first bus and have a first bus width corresponds to that of said first bus; and
a second bus controller configured to be connected with said second bus and have a second bus width corresponds to that of said second bus,
wherein said first bus width is different from said second bus width,
said control unit converts said first bus width of said write data into said second bus width, and outputs said converted write data to said second bus controller.

5. A control apparatus comprising:
a first CPU;
a first memory configured to belong to said first CPU;
a first bus configured to be connected with said first CPU and said first memory;
a second CPU;
a second memory configured to belong to said second CPU;
a second bus configured to be connected with said second CPU and said second memory; and
a data transfer control circuit configured to be connected between said first bus and said second bus,
wherein said data transfer control circuit includes:
a temporary memory configured to temporarily stores a first address and a first write data which are outputted by said first CPU through said first bus; and
a control unit configured to translate said first address into a second address in said second memory with reference to an address translation table,
wherein said control unit occupies said second bus to write said first write data to said second address in said second memory through said second bus, when said first CPU releases said first bus after outputting said first address and said first write data to said data transfer control circuit through said first bus.

6. The control apparatus according to claim 5, wherein said data transfer control circuit further includes:
a judging unit configured to judge whether or not outputting said first write data through said second bus is acknowledged,
wherein said control unit writes said first write data to said second address in said second memory through said second bus.

7. The control apparatus according to claim 5, wherein said data transfer control circuit further includes:
a first bus controller configured to be connected with said first bus and have a first bus width corresponds to that of said first bus, and
a second bus controller configured to be connected with said second bus and have a second bus width corresponds to that of said second bus,
wherein said first bus width is different from said second bus width,
said second bus controller converts said first bus width of said write data into said second bus width, and outputs said converted write data to said second bus.

8. The control apparatus according to claim 5, wherein said data transfer control circuit further includes:
a first bus controller configured to be connected with said first bus and have a first bus width corresponds to that of said first bus, and
a second bus controller configured to be connected with said second bus and have a second bus width corresponds to that of said second bus,
wherein said first bus width is different from said second bus width,
said control unit converts said first bus width of said write data into said second bus width, and outputs said converted write data to said second bus controller.

9. The control apparatus according to claim 5, wherein said first CPU, said first memory, said first bus, said second CPU, said second memory and said second bus are placed on one chip.

10. A data transfer method by using a data transfer control circuit which is connected between a first bus and a second bus, wherein said first bus is connected with a first CPU (Central Processing Unit) and a first memory, said second bus is connected with a second CPU and a second memory, said data transfer method comprising:
(a) outputting a first address and a first write data to said data transfer control circuit through said first bus by said first CPU, while occupying said first bus by said first CUP;
(b) temporarily storing said first address and said first write data by said data transfer control circuit;
(c) translating said first address into a second address in said second memory with reference to an address translation table by said data transfer control circuit;
(d) releasing said first bus by said first CPU; and
(e) outputting said first write data to said second address in said second memory through said second bus by said data transfer control circuit, while occupying said second bus by said data transfer control circuit.

11. The data transfer method according to claim 10, wherein said step (e) includes:
(e1) judging whether or not outputting said first write data through said second bus is acknowledged, and
(e2) outputting said first write data to said second address in said second memory through said second bus based on said judging result, by said data transfer control circuit.

12. The data transfer method according to claim 10, wherein said step (e) includes:
(e3) converting a first bus width of said write data into a second bus width by said data transfer control circuit,
said first bus width is a bus width of said first bus, and
said second bus width is a bus width of said second bus.

13. A computer-readable medium comprising code that, when executed by a computer including a data transfer control circuit, which is connected between a first bus and a second bus, said first bus is connected with a first CPU (Central Processing Unit) and a first memory, said second bus is connected with a second CPU and a second memory, causes said computer to perform the following:
(f) receiving a first address and a first write data through said first bus from said first CPU, while said first bus is occupied by said first CUP;
(g) temporarily storing said first address and said first write data;
(h) translating said first address into a second address in said second memory with reference to an address translation table;
(i) occupying said second bus after said first CPU releases said first bus; and
(j) outputting said first write data to said second address in said second memory through said second bus.

14. The computer-readable medium according to claim 13, wherein said step (j) includes:
(j1) judging whether or not outputting said first write data through said second bus is acknowledged, and
(j2) outputting said first write data to said second address in said second memory through said second bus based on said judging result.

15. The computer-readable medium according to claim 13, wherein said step (j) includes:
(j3) converting a first bus width of said write data into a second bus width,
said first bus width is a bus width of said first bus, and
said second bus width is a bus width of said second bus.
